(19) United States
(12) Patent Application Publication
(10) Pub. No.: US 2003/0235680 A1
(43) Pub. Date: Dec. 25, 2003

(54) Method of rolling material

(76) Inventor: Artin Zakarian, City of Industry, CA (US)

Correspondence Address: MOSER, PATTERSON & SHERIDAN, L.L.P., Suite 1500, 3040 Post Oak Blvd., Houston, TX, 77056, US

(21) Appl. No.: 10/177,484

(22) Filed: Jun. 21, 2002

(51) Int. Cl. B32B 3/30; B29C 53/22; B21F 1/00; B21C 37/00; B22F 5/00; B21D 13/00; B21D 5/08; B21B 39/20

(52) U.S. Cl. 428/184; 264/286; 428/595; 428/603; 72/176; 72/252.5

(57) ABSTRACT

A method utilized in rolling up materials. In particular, the invention relates to method of rolling corrugated sheets of material. More particularly, the invention relates to a method of rolling pre-formed corrugated sheets of thermoplastic based material. The present invention relates to a method of rolling sheets of thermoplastic material that comprises providing a pre-formed sheet of thermoplastic material, forming a plurality of corrugations on said pre-formed sheet of thermoplastic material; wherein the corrugated shape is made up of inwardly and outwardly extending undulations, rolling the corrugated sheet of thermoplastic material from a first end to a second end; wherein the undulations of a first layer are nestable with the undulations of each subsequent layer of the pre-formed corrugated sheet thermoplastic material.

### BACKGROUND OF THE INVENTION

1. Field of the Invention

Embodiments of the present invention generally relate to a method utilized in rolling up materials. In particular, the invention relates to method of rolling corrugated sheets of material. More particularly, the invention relates to a method of rolling pre-formed corrugated sheets of thermoplastic based materials.

2. Description of the Related Art

The housing industry has been a constant in the economy for many generations. Over the last couple of decades, homeowners have been spending more time and money repairing, remodeling and enhancing their homes. One such product that consumers use not only in, but on and around their homes has been either flat or corrugated sheets of material. The flat or corrugated sheets come in a variety of different materials such as galvanized steel, polycarbonate based material, thermoplastic based material, poly vinyl chloride (PVC) based material and a fiberglass based material. The materials listed above are virtually unbreakable, block the ultraviolet trays from the sun, are hail resistant, have great snow load capacity and can be made flame retardant. The consumer has found a variety of uses for these sheets of material. The consumer can and has used this material for roofing material, fencing material and as enclosures for pools and as a greenhouse structure. In addition, not only can the materials of the polycarbonate, thermoplastic, poly vinyl chloride and fiberglass base come in either an opaque material or a translucent material, but they also come in a variety of colors such as clear, white, green, tan or smoke. The material is made in a variety of sizes from 26″ in width to a length that spans from 8′ to 12′, with 26″ be the most common width. The most popular form of either the flat or corrugated sheet of material is one with thermoplastic based characteristics so that it can be molded. In addition, another reason the material with the thermoplastic based qualities is the most popular is because it weighs less, is easier to work with and is the most cost effective. The consumers can purchase this material from a variety of sources including various independent producers to large do it yourself stores such as Home Depot® and Lowes®.

Although the sheets can be made from a variety of materials, in a variety of either clear or opaque colors, and the material has a variety of uses, the material does have some downsides. First, the material can be hard to transport. Second, the amount of material used once it reaches the job-site may not be the same as what was actually purchased, resulting in product going unused and wasted. Third, the size of the material may prove difficult to handle. Fourth, the amount of material actually purchased may not be the same as what was actually needed, resulting in a shortage of the product.

From the foregoing, it can be seen that it would be quite desirable to provide a method that permits the rolling of a flat or corrugated sheet of material that is easier to transport from the store to the job site.

A further need exists for a method that permits the rolling of flat or corrugated sheet of the material made from either galvanized steel, polycarbonate based material, thermoplastic based material, poly-vinyl chloride (PVC) based material and/or a fiberglass based material that can be rolled out so it can be cut to different lengths to minimize waste.

A further need exists for a method that permits the rolling of a flat or corrugated sheet of thermoplastic material that is easier to store at the job-site, easier to transport from the store to the job-site, and that can be rolled out so it can be cut to different lengths to minimize waste.

### SUMMARY OF THE INVENTION

The present invention first relates to a method utilized in rolling up sheets of materials. Particularly, the invention relates to method of rolling corrugated sheets of material. More particularly, the invention relates to method of rolling corrugated sheets of thermoplastic material. In one embodiment, a method of rolling sheets of thermoplastic material comprises providing a pre-formed sheet of thermoplastic material, forming a plurality of corrugations on said pre-formed sheet of thermoplastic material; wherein the corrugated shape is made up of inwardly and outwardly extending undulations, rolling the corrugated sheet of thermoplastic material from a first end to a second end; wherein the undulations of a first layer are nestable with the undulations of each subsequent layer of the pre-formed corrugated sheet thermoplastic material.

In another embodiment, a method of rolling sheets of thermoplastic material comprises providing a pre-formed corrugated sheet of thermoplastic material; wherein the pre-formed corrugated shape is made up of inwardly and outwardly extending undulations, rolling the pre-formed corrugated sheet of material from a first end to a second end, wherein the undulations of a first layer are nestable with the undulations of each subsequent layer of the pre-formed corrugated sheet thermoplastic material.

In still another embodiment, a method of rolling sheets of material comprises providing a pre-formed sheet of material, forming a plurality of corrugations on said pre-formed sheet of material; wherein the corrugated shape is made up of inwardly and outwardly extending undulations, rolling the corrugated sheet of material from a first end to a second end; wherein the undulations of a first layer are nestable with the undulations of each subsequent layer of the pre-formed corrugated sheet of material. The material is selected from a group of galvanized steel, polycarbonate material, thermoplastic material, poly-vinyl chloride material and fiberglass material.

In still another embodiment, a method of rolling sheets of material comprises providing a pre-formed corrugated sheet of material, wherein the preformed corrugated shape is made up of inwardly and outwardly extending undulations, rolling the pre-formed corrugated sheet of material from a first end to a second end; wherein the undulations of a first layer are nestable with the undulations of each subsequent layer of the preformed corrugated sheet of material. The material is selected from a group of galvanized steel, polycarbonate material, thermoplastic material, poly-vinyl chloride material and fiberglass material.

In still another embodiment, a roll of corrugated material comprises a plurality of layers of material, each layer including corrugations, wherein the corrugated shape is made of inwardly and outwardly extending undulations; whereby the undulations of a first layer are nestable with the undulations of each subsequent layer of the corrugated sheet of material. The material is a thermoplastic material.

### BRIEF DESCRIPTION OF THE DRAWINGS

So that the manner in which the above recited features of the present invention, and other features contemplated and claimed herein, are attained and can be understood in detail, a more particular description of the invention, briefly summarized above, may be had by reference to the embodiments thereof which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a perspective view of a piece of pre-formed thermoplastic based material with corrugations.

FIG. 2 is a perspective view of FIG. 1 of the pre-formed thermoplastic based material after it has been rolled showing the nesting of the inwardly and outwardly extending undulations of the corrugations from one layer to each subsequent layer.

### DETAILED DESCRIPTION OF THE PREFERRED EMBODIMENT

The present invention is a method of rolling up a piece of pre-formed corrugated thermoplastic material.

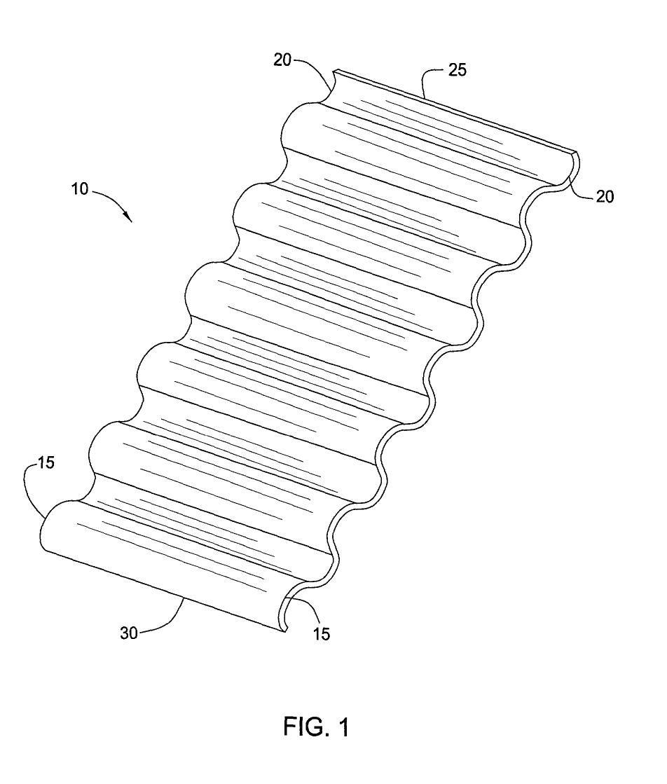

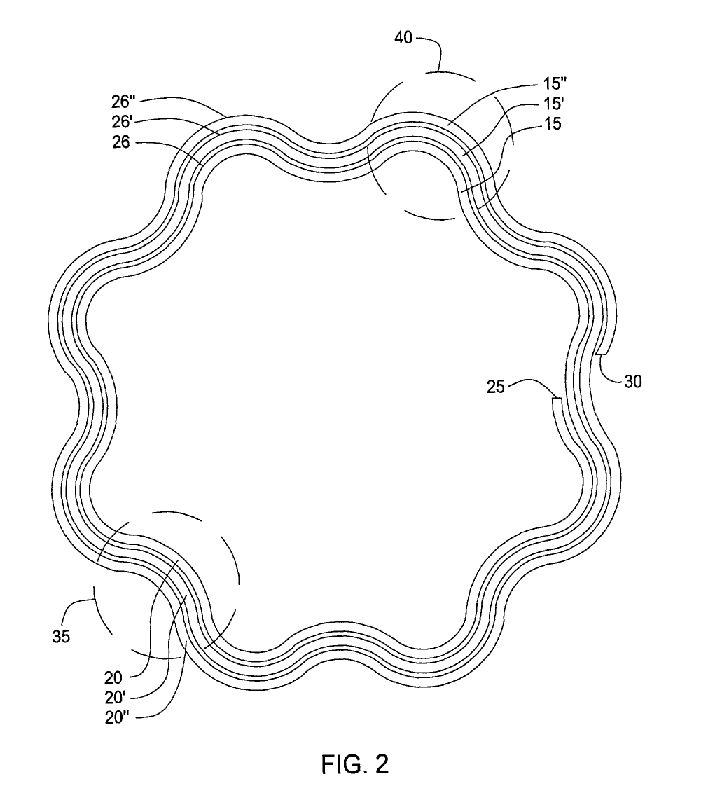

FIG. 1 is a perspective view of the pre-formed thermoplastic based material 10. The pre-formed thermoplastic based material 10 is formed with corrugations. The corrugations include outwardly extending undulations 15 and inwardly extending undulations 20. In addition, the corrugations alternate between the outwardly extending undulations 15 and the inwardly extending undulations 20. The outwardly extending undulation 15 forms the peak or ridge of the pre-formed thermoplastic based material 10 and the inwardly extending undulation 20 forms the valley of the pre-formed thermoplastic based material 10. The pre-formed thermoplastic based material 10 has a first end 25 and a second end 30. The outwardly extending undulation 15 of the corrugation is fabricated so that it will nest with the outwardly extending undulations 15′, 15″ formed on each of the subsequent layers 26′, 26″ of the thermoplastic material when the pre-formed thermoplastic based material 10 is rolled up by hand or spooled onto an apparatus(not shown) used to secure and roll-up the pre-formed thermoplastic based material 10 for subsequent shipping or cutting as shown in FIG. 2. The inwardly extending undulation 20 of the corrugation is fabricated so that it will nest with the inwardly extending undulations 20′, 20″ formed on each of the subsequent layers 26′, 26″ of the thermoplastic material when the pre-formed thermoplastic based material 10 is rolled up by hand or spooled onto an apparatus (not shown) used to secure and roll-up the pre-formed thermoplastic based material 10 for subsequent shipping or cutting as shown in FIG. 2. The pre-formed thermoplastic based material 10 is usually fabricated in sheets of eight feet by twenty-six inches to twelve feet by twenty-six inches. Because the present invention provides a method of rolling up pre-formed thermoplastic based material 10, the sheets of the present invention can be fabricated to the lengths of fifty feet to one hundred feet or more. The present invention provides a method of rolling up the pre-formed thermoplastic based material 10 so the consumer is able to either order for example, a roll of five feet of the pre-formed thermoplastic based material 10 or one hundred feet of the preformed thermoplastic based material 10 for shipment to the job-site, or the consumer can go to the retail store and have the customer service agent roll out and cut a specific size for the consumer as shown in FIG. 2. The present invention allows the consumer to have a choice in the length of the piece and does not limit the consumer to the standard precut sizes.

FIG. 2 is a plan perspective of one continuous piece of the pre-formed thermoplastic based material 10 showing the first end 25 and the second end 30 in rolled-up or spooled perspective. As the pre-formed thermoplastic based material 10 is rolled up, the layers of the pre-formed thermoplastic based material 10, designated as 26, 26′, 26″ and so on, are rolled to lay on top of each other. To begin, layer 26, is the layer closest to the first end 25, and is the innermost layer of the rolled continuous sheet of pre-formed thermoplastic based material 10 as shown in FIG. 2. Also shown in FIG. 2, layer 26″ is the layer closest to second end 30, and is the outermost layer of the rolled continuous sheet of pre-formed thermoplastic based material 10. The intermediate layer, layer 26′ is the layer in between layers 26 and 26″ respectively. As the continuous piece of pre-formed thermoplastic based material 10 is rolled, the outwardly extending undulation 15 of the corrugation formed on layer 26 nests with the outwardly extending undulation 15′ of the corrugation of layer 26′ of the pre-formed thermoplastic based material 10. In addition, as the continuous piece of pre-formed thermoplastic based material 10 is rolled, the inwardly extending undulation 20 of the corrugation formed on layer 26 nests with the inwardly extending undulation 20′ of the corrugation formed on layer 26′ of the pre-formed thermoplastic based material 10. Thus, as the continuous piece of pre-formed thermoplastic based material 10 is rolled from the first end 25 to the second end 30, the first layer 26 is covered by subsequent layers 26′, 26″, and so on, and the outwardly extending undulation 15, 15′, 15″ of the corrugations and so on, formed on their respective layers 26, 26′, 26″, and so on, nest together, and the inwardly extending undulations 20, 20′ 20″ of the corrugations and so on, formed on their respective layers 26, 26′, 26″, nest together as shown in FIG. 2. The nesting area 35, shown in FIG. 2, is the nesting area for the inwardly extending undulations 20, 20′ 20″ of the corrugations and so on, as the rolled continuous sheet of pre-formed thermoplastic based material 10 is rolled. The nesting area 40, shown in FIG. 2, is the nesting area for the outwardly extending undulations 15, 15′, 15″ of the corrugations and so on, as the rolled continuous sheet of pre-formed thermoplastic based material 10 is rolled. In the process of rolling the continuous sheet of pre-formed thermoplastic based material 10, the first end is subsequently covered by layer 26′, 26″ and so on, until the outermost layer is 26″, which is the layer closest to the second end 30 as shown in FIG. 2. At this point, a continuous sheet of pre-formed thermoplastic based material 10 has been rolled. The length of the roll can vary from one roll to the next, for example fifty feet. The present invention creates a method for rolling the continuous sheet of preformed thermoplastic based material 10 so that the length of the sheet can by varying lengths. For example, instead of having to buy a pre-cut piece of ten feet, when the consumer wants a twenty five foot piece, the consumer can have the retailer either ship him/her a piece cut off of a continuos roll to match the customers twenty five foot request. Likewise, the consumer could also order and have shipped directly to his job-site a one hundred foot roll of the continuous sheet of pre-formed thermoplastic based material 10 so the consumer could roll out and cut off exactly the size needed to complete the job.

While the foregoing is directed to embodiments of the present invention, other and further embodiments of the invention may be devised without departing from the basic scope thereof, and the scope thereof is determined by the claims that follow.

1. A method of rolling sheets of thermoplastic material comprising:
providing a pre-formed sheet of thermoplastic material;
forming a plurality of corrugations on said pre-formed sheet of thermoplastic material; wherein the corrugated shape is made up of inwardly and outwardly extending undulations; and
rolling the corrugated sheet of thermoplastic material from a first end to a second end; wherein the undulations of a first layer are nestable with the undulations of each subsequent layer of the sheet.

2. A method of rolling sheets of thermoplastic material comprising:
providing a pre-formed corrugated sheet of thermoplastic material wherein the pre-formed corrugated shape is made up of inwardly and outwardly extending undulations; and
rolling the pre-formed corrugated sheet of material from a first end to a second end, wherein the undulations of a first layer are nestable with the undulations of each subsequent layer of the pre-formed corrugated sheet thermoplastic material.

3. A method of rolling sheets of material comprising:
providing a pre-formed sheet of material;
forming a plurality of corrugations on said pre-formed sheet of material; wherein the corrugated shape is made up of inwardly and outwardly extending undulations; and
rolling the corrugated sheet of material from a first end to a second end, wherein the undulations of a first layer are nestable with the undulations of each subsequent layer of the pre-formed corrugated sheet of material.

4. The method of rolling sheets of material of claim 4, whereby the material is selected from a group of galvanized steel, polycarbonate material, thermoplastic material, poly-vinyl chloride material and fiberglass material.

5. A method of rolling sheets of material comprising:
providing a pre-formed corrugated sheet of material; wherein the pre-formed corrugated shape is made up of inwardly and outwardly extending undulations; and
rolling the pre-formed corrugated sheet of material from a first end to a second end, wherein the undulations of a first layer are nestable with the undulations of each subsequent layer of the preformed corrugated sheet of material.

6. The method of rolling sheets of material of claim 5, whereby the material is selected from a group of galvanized steel, polycarbonate material, thermoplastic material, poly-vinyl chloride material and fiberglass material.

7. A roll of corrugated material comprising:
a plurality of layers of material, each layer including corrugations, wherein the corrugated shape is made up of inwardly and outwardly extending undulations;
whereby the undulations of a first layer are nestable with the undulations of each subsequent layer of the corrugated sheet material.

8. The roll of claim 7, wherein the material is a thermoplastic material.
